(19) United States
(12) Patent Application Publication
(10) Pub. No.: US 2026/0235271 A1
(43) Pub. Date: Aug. 13, 2026

(54) DUAL FUNCTION MAP LIGHT

(71) Applicant: Tesla, Inc., Austin, TX (US)

(72) Inventors: Matthew Urrea, San Francisco, CA (US); Bharath Swaminathan, Livermore, CA (US); James Normantas, Palo Alto, CA (US); Harish Anantharaman, Berlin (DE); Anthony DeBartolo, Hamilton (CA); Alessandro Bernardis, Fremont, CA (US); Shakeel Theodore, Fremont, CA (US)

(21) Appl. No.: 19/148,086

(22) PCT Filed: Jan. 22, 2024
(86) PCT No.: PCT/US2024/012386

§ 371 Date: Jul. 15, 2025

Related U.S. Application Data
(60) Provisional application No. 63/440,874, filed on Jan. 24, 2023.

(51) Int. Cl. F21S 41/20; F21V 23/04; F21Y 115/10

(52) U.S. Cl. CPC F21S 41/285; F21V 23/0485; F21Y 2115/10

(57) ABSTRACT

A lighting system (100, 1000, 1100) is provided that includes an outer lens (240, 940, 1030, 1130) with a functional zone (244) and an ambient zone (242). The lighting system (100, 1000, 1100) comprises a functional conditional and an ambient condition. When the lighting system (100, 1000, 1100) is in the functional condition it produces a directional light through the functional zone (244) of the outer lens (240, 940, 1030, 1130). When the system (100, 1000, 1100) is in the ambient condition it produces and ambient light in the ambient zone (242) of the outer lens (240, 940, 1030, 1130). The system (100, 1000, 1100) further comprises a touch sensor (300) that a user may use to switch the system between conditions.

### CROSS-REFERENCE TO RELATED APPLICATION

This application is a non-provisional of and claims priority to U.S. Provisional Patent Application No. 63/440,874, entitled “DUAL FUNCTION MAP LIGHT,” filed on Jan. 24, 2023, which is hereby incorporated by reference in its entirety and for all purposes.

### TECHNICAL FIELD

This application relates to in vehicle lighting, and more particularly relates to a vehicle light that supports directional light, ambient light, and touch sensing capabilities.

### BACKGROUND

In the context of lights, there is a need for directional lights and ambient lights. Thus, when both lights are needed in a small space, there becomes a need to have both functionalities. Ambient lighting traditionally uses diffusive materials that scatter light in many different directions. Directional lighting uses translucent materials with specialized optics designed to collimate light and direct it towards a particular target zone. Therefore, shining directional light towards a target zone through the same optic used for ambient lighting requires overcoming additional challenges. Further functionality such as touch sensing may also be needed in the same small area or confined space. The light may need to path through the same area used for sensing touch. However, there is a need to support all three functionalities in the confined space.

### SUMMARY

An aspect directed towards a lighting system comprising an ambient condition and a functional condition, wherein when the system is in the functional condition a functional LED is lit and directed via optics to produce a directional light, wherein when the system is in the ambient condition an ambient LED is lit and is diffused and directed to produce an ambient light, wherein the directional light and the functional light are produced from the same optic while maintaining their distinct characteristics.

In some aspects, the techniques described herein relate to a lighting system including: a first light source; a second light source; a first optic configured to receive light from the first light source for scattering into a first light; a second optic configured to receive light from the second light source for directing into a second light; and an outer lens including an ambient zone and a functional zone, wherein the ambient zone is configured to receive the first light, wherein the functional zone is configured to receive the second light, and wherein: the ambient zone diffuses the first light into an ambient light that travels in a plurality of directions when the ambient zone receives the first light; and the functional zone diffuses the second light into a directional light that travels substantially in a direction when the functional zone receives the second light.

In some aspects, the techniques described herein relate to a lighting system, further including: a first printed circuit board (PCB); and a second printed circuit board (PCB), wherein the first light source is mounted on the first PCB, and wherein the second light source is mounted on the second PCB.

In some aspects, the techniques described herein relate to a lighting system, wherein the second optic is positioned below the second PCB and above the first optic.

In some aspects, the techniques described herein relate to a lighting system, wherein the first optic is positioned below the second optic and above the outer lens, and wherein the second light passes through the first optic before being received by the functional zone.

In some aspects, the techniques described herein relate to a lighting system, wherein the second optic is adjacent to a bottom surface of the second PCB and a top surface of the first optic, and wherein the bottom surface of the second PCB and the top surface of the first optic are substantially parallel.

In some aspects, the techniques described herein relate to a lighting system, wherein the bottom surface of the second PCB and the top surface of the first optic are substantially perpendicular to a surface of the first PCB that is adjacent to the first optic.

In some aspects, the techniques described herein relate to a lighting system, further including: a sensor electrically connected to the first PCB, wherein the sensor is configured to cause the first light source or the second light source to be turned on or off responsive to a user interaction.

In some aspects, the techniques described herein relate to a lighting system, wherein the sensor is a touch sensor, and wherein the touch sensor causes the second light source to be turned on or off responsive to a user touch on a touch surface of the outer lens.

In some aspects, the techniques described herein relate to a lighting system, wherein the touch sensor includes a first electrode and a second electrode, and wherein the touch surface of the outer lens is positioned between the first electrode and the second electrode.

In some aspects, the techniques described herein relate to a lighting system including: a first light source; a second light source; a first optic configured to receive light from the first light source for generating a first light; a second optic configured to receive light from the second light source for generating a second light; and an outer lens including an ambient zone and a functional zone, wherein the ambient zone is configured to diffuse the first light into an ambient light, and wherein the functional zone is configured to diffuse the second light into a directional light.

In some aspects, the techniques described herein relate to a lighting system, wherein the functional zone is positioned around a first end and/or a second end of the outer lens.

In some aspects, the techniques described herein relate to a lighting system, further including: a printed circuit board (PCB), wherein the first light source and the second light source are mounted on the PCB.

In some aspects, the techniques described herein relate to a lighting system, wherein the first optic is positioned below the PCB and above the outer lens.

In some aspects, the techniques described herein relate to a lighting system, wherein the second optic is positioned between the PCB and the first optic.

In some aspects, the techniques described herein relate to a lighting system including: a first light source; a second light source; an optic configured to: receive light from the first light source for generating a first light; and receive light from the second light source for generating a second light; and an outer lens including an ambient zone and a functional zone, wherein the ambient zone is configured to diffuse the first light into an ambient light, and wherein the functional zone is configured to diffuse the second light into a directional light.

In some aspects, the techniques described herein relate to a lighting system, wherein the optic includes a first portion and a second portion, wherein the light from the first light source passes through the first portion and the second portion for generating the first light, and wherein the light from the second light source passes through the second portion for generating the second light.

In some aspects, the techniques described herein relate to a lighting system, further including: a printed circuit board (PCB), wherein the first light source and the second light source are mounted on the PCB.

In some aspects, the techniques described herein relate to a lighting system, wherein the PCB is positioned above the outer lens and the optic.

In some aspects, the techniques described herein relate to a lighting system, wherein a length of the outer lens is about 300 mm, and wherein a length of the functional zone is between 20 mm to 30 mm.

In some aspects, the techniques described herein relate to a lighting system, wherein the ambient zone is larger in size than the functional zone, and wherein the ambient zone overlaps with the functional zone.

In some aspects, the techniques described herein relate to a lighting system including: at least one PCB; at least one ambient led; at least one functional led; a first optic configured to receive a light from the at least one ambient led and diffuse said light into a first light; a second optic configured to receive light from the at least one functional led and direct it into a second light; and an outer lens including a functional zone and an ambient zone, wherein the second light is further directed through the first optic, wherein the first light is more diffuse than the second light, wherein the second light is configured to path through the functional zone and the first light is configured to pass through the ambient zone, and wherein the functional zone and the ambient zone are at least partially the same.

In some aspects, the techniques described herein relate to a lighting system including: an ambient PCB; a functional PCB; at least one ambient led mounted to the ambient PCB; at least one functional led mounted to the functional PCB; a first optic configured to receive a light from the at least one ambient led and diffuse said light into a first light; a second optic configured to receive light from the at least one functional led and direct it into a second light; an outer lens including a functional zone and ambient zone; and a touch sensor configured to sense a user touch of the outer lens, wherein the functional PCB is substantially perpendicular to the ambient PCB, wherein the second light is configured to path through the functional zone and the first light is configured to pass through the ambient zone, and wherein the functional zone and the ambient zone are at least partially the same.

In some aspects, the techniques described herein relate to a lighting system for a vehicle, the lighting system including: at least one ambient led; at least one functional led; a first optic configured to receive a light emitted by the at least one ambient led and diffuse said received light into a first light; a second optic configured to receive a light emitted by the at least one functional led and direct the received light into a second light; and an outer lens including an ambient zone positioned to receive the first light and a functional zone positioned to receive the second light, at least a portion of the functional zone overlapping the ambient zone.

### BRIEF DESCRIPTION OF THE DRAWINGS

The present inventions are described with reference to the accompanying drawings, in which like reference characters reference like elements, and wherein:

FIG. 1 is a representation of a lighting system in accordance with aspects of the present disclosure.

FIG. 2A illustrates the zones of the lighting system while in the functional condition.

FIG. 2B illustrates the zones of the lighting system while in the ambient condition.

FIG. 3A illustrates a side view of the lighting system while in the functional condition.

FIG. 3B illustrates a side view of the lighting system while in the ambient condition.

FIG. 4A illustrates a view of the light path and intensity of the lighting system while in the functional condition.

FIG. 4B illustrates an alternative view of the light path and intensity of the lighting system while in the functional condition.

FIG. 4C illustrates an alternative view of the light path of the lighting system while in the functional condition.

FIG. 5 illustrates a view of the light path and intensity of the lighting system while in the ambient condition.

FIG. 6 illustrates an alternative embodiment of the lighting system in accordance with aspects of the present disclosure.

FIG. 7A illustrates a side view of an alternative embodiment of the lighting system in accordance with aspects of the present disclosure while in a functional condition.

FIG. 7B illustrates a side view of an alternative embodiment of the lighting system in accordance with aspects of the present disclosure while in an ambient condition.

FIG. 8 illustrates a side view of the touch sensor of the lighting system.

FIG. 9 illustrates a representation of a single optic and an outer lens in accordance with aspects of the present disclosure.

FIG. 10A illustrates a top view of a lighting system in accordance with some aspects of the present disclosure.

FIG. 10B illustrates a cross-sectional view of the lighting system of FIG. 10A in accordance with some aspects of the present disclosure.

FIG. 11 illustrates a cross-sectional view of a lighting system in accordance with some aspects of the present disclosure.

### DETAILED DESCRIPTION

Generally described, one or more aspects of the present disclosure relate to a dual function light and a touch sensor associated with the vehicle light. The dual function light disclosed herein has general applicability in many products and industries including vehicles, boats, residential, commercial, aerospace, and industrial. For ease of description, the vehicle light and touch sensor will be described in the context of vehicles and more specifically in the context of electric vehicles. However, the application of the dual function light disclosed herein is not limited to vehicles and has applicability in many industries.

Traditional approaches to dual function lights have required more than one distinct optic/lens, have failed to produce a directional light and an ambient light within the same active zone, and have failed to maintain a sharp distinction between the directional light and the ambient light zones when only the directional light is active and shining through the common lens.

To address some of the deficiencies associated with traditional dual function lighting systems, the present disclosure describes a lighting system, and components thereof, that has a reduced overall size, reduced components, reduced cost, and dual functionality through a single lens.

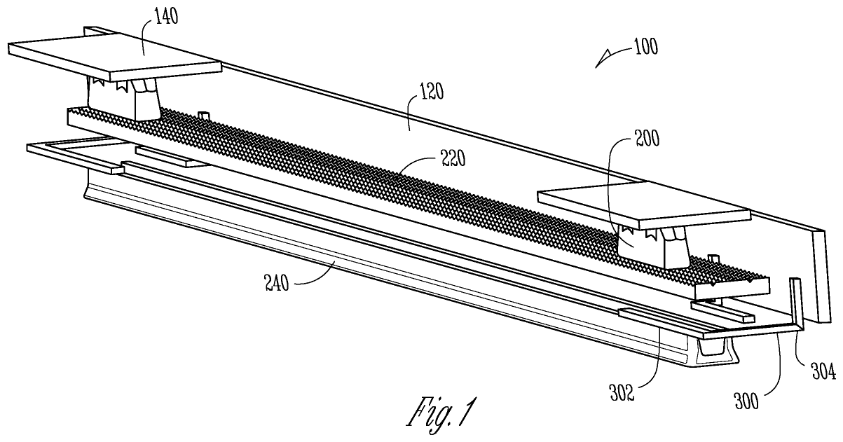

FIG. 1 is a representation of a lighting system 100 in accordance with aspects of the present application. In certain embodiments the lighting system 100 comprises an ambient printed circuit board (PCB) 120 and a functional PCB 140. In certain embodiments the ambient PCB 120 is connected to the functional PCB 140. In the present embodiment there are two functional PCBs 140. There may be more or less functional PCB 140. The ambient PCB 120 and the functional PCB 140 may be perpendicular in relation to each other as shown in the present embodiment. The ambient PCB 120 is configured to produce an ambient light 122. The functional PCB 140 is configured to produce a functional light 142. The functional light 142 may also be referred to as the directional light 142.

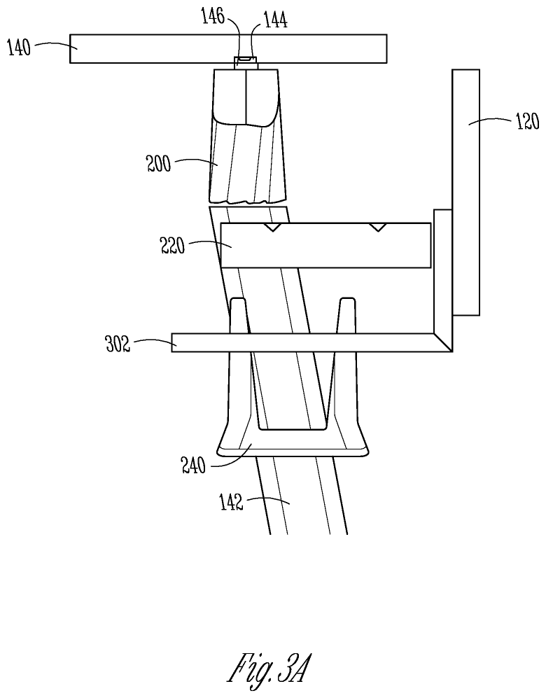

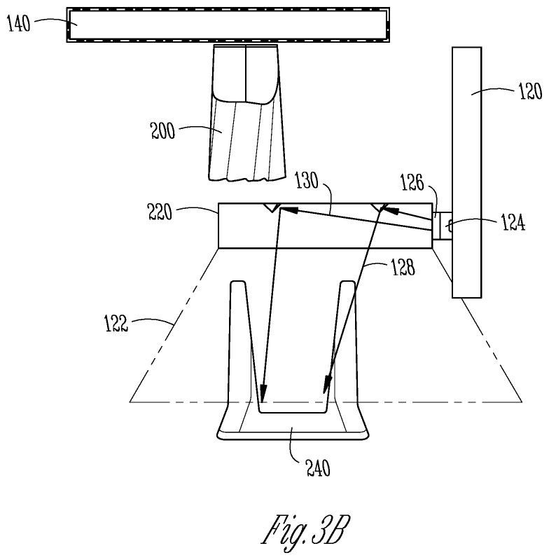

The lighting system 100 may further comprise a functional optic 200, a micro optic 220, and an outer lens 240. The functional optic 200 may be configured to guide the functional light produced by a function LED 144 (shown in FIG. 3A) located on the functional PCB 140. The micro optic 220, which may also be referred to as a textured light guide, may be configured to guide an ambient light 122 (shown in FIG. 3B) and a functional light 142 (shown in FIG. 3A). In the present embodiment the functional optic 200 is configured to guide the functional light 142 through the micro optic 220. In the present embodiment, the functional optic 200 may be adjacent to a bottom surface of the functional PCB 140. The functional optic 200 may be adjacent to a top surface of the micro optic 220. As illustrated in FIG. 1, the bottom surface of the functional PCB 140 and the top surface of the micro optic 220 may be substantially perpendicular to a surface of the ambient PCB 120 that is adjacent to the micro optic 220. Although not illustrated in FIG. 1, there may be a small gap between the functional optic 200 and the micro optic 220. In addition there may be a gap between the Functional LED 144 and the functional optic 200.

In some embodiments, the outer lens 240 may include one or more materials that can diffuse light received from the functional optic 200 and/or the micro optic 220. For example, the outer lens 240 may include light diffusing material such as polycarbonate along with optionally added diffusive additives.

In some embodiments, the functional optic 200 and the micro optic 220 may be made of or include the same material that can direct and/or scatter light. For example, the functional optic 200 and the micro optic 220 may be made of the same material, such as poly methyl methacrylate (PMMA) or acrylic. By adopting various optical designs and/or assembly configurations, the functional optic 200 may be configured to direct the functional light 142 to the outer lens 240, while the micro optic 220 may be configured to scatter the ambient light 122. For example, as shown in FIG. 1, the functional optic 200 and the micro optic 220 have distinct geometries and/or shapes that allow the ambient light 122 passed through the micro optic 220 to be more scattered than the functional light 142. As another example, although not readily observed from FIG. 1, the functional optic 200 may have a distinct surface design such as various textures, grains, coatings that allow the functional light 142 to be more directional or specular than the ambient light 122.

Although not illustrated in FIG. 1, in some embodiments, certain coating, filming, or painting techniques can be applied to the outer lens 240 such that the lighting system 100 may have various appearances. More specifically, a bottom side of the outer lens 240 that is readily exposed to view by a user may be coated, filmed, or painted to exhibit metallic or other appearances. For example, metallic physical vapor deposition (PVD) coating may be applied to a portion of the outer lens 240 such that when the lighting system 100 does not produce the functional light 142 or the ambient light 122, the lighting system 100 may present metallic or dark color (e.g., black) appearance to a user rather than the appearance of the material that is included in the outer lens 240. Other materials that may be applied to a surface of the outer lens 240 include materials such as in mold label (IML) films, Shytech paint, or the like. Advantageously, coating, filming or painting the outer lens 240 may increase aesthetic appeal of the lighting system 100.

The lighting system 100 may further comprise a touch sensor 300. The touch sensor 300 may be configured to sense a touch, swipe, contact, push, gesture, or other form of touch. The touch sensor 300 may comprise touch sensing electrode 302. The touch sensing electrode 302 may be an electrode. In the present embodiment the touch sensor 300 comprises a touch sensor connector portion 304 which is connected to the ambient PCB 120.

In some embodiments, the functional PCB 140 and the ambient PCB 120 can be assembled and connected with each other using various board to board contact techniques. For example, the functional PCB 140 can be connected to the ambient PCB 120 through pogo pin connectors. As another example, the functional PCB 140 can be connected to the ambient PCB 120 through spring contacts. As still another example, the functional PCB 140 can be connected to the ambient PCB 120 through flexible printed circuits (FPC). As yet another example, the functional PCB 140 can be connected to the ambient PCB 120 through conductive traces (e.g., inks) that are deployed on a housing (not shown in FIG. 1) that houses the lighting system 100.

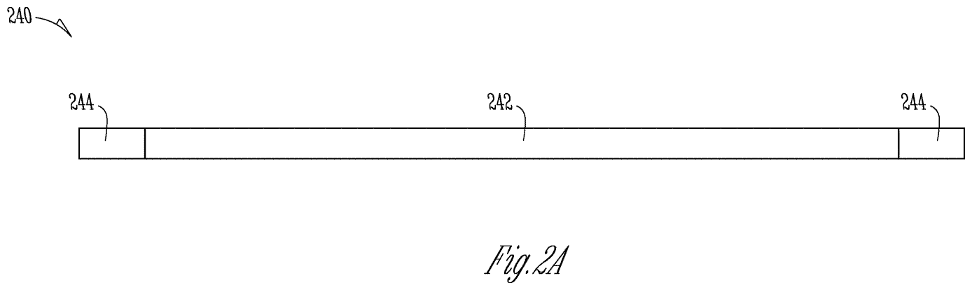

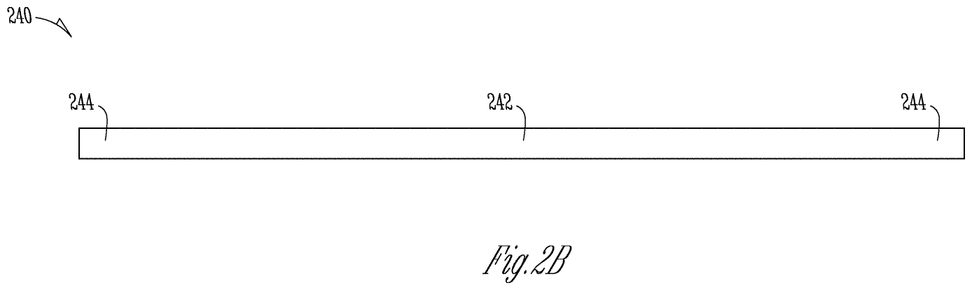

FIG. 2A is an embodiment of the lighting system 100 in a functional condition. The lighting system may start in the functional condition or another condition such as an off condition. The outer lens 240 comprises an ambient zone 242 and one or more functional zones 244. In the present embodiment, the lighting system 100 comprises a functional zone 244 at each end. The ambient zone 242 is configured to overlap with the functional zone 244. In the present embodiment, the height of the outer lens 240 is 8 millimeters (mm) and the length is 300 mm. The length of each functional zone 244 is 25 mm. However, it should be appreciated that this value may be 5 mm, 10 mm, 15 mm, 20 mm, 25 mm, 30 mm, 35 mm, 40 mm, or any other value. When the lighting system 100 is in a functional condition at least one function zone 244 is lit. When the functional zone 244 is lit, the functional zone 244 provides a directional light 142.

Although not illustrated in FIG. 2A, in some embodiments, the outer lens 240 may include more than two or less than two functional zones 244. For example, the outer lens 240 may include three functional zones 244. One functional zone 244 may be at one end of the outer lens 240, another functional zone 244 may be at the other end of the outer lens 240, the other functional zone 244 may be at the center of the outer lens 240. In some embodiments, the functional zone 244 may overlap with the ambient zone 242. In some embodiments, the ambient zone 242 may include the entire outer lens 240. In these embodiments, the functional zone 244 may be a portion of the ambient zone 242.

Under a functional condition of the lighting system 100, the functional zone 244 may be lit while the remaining ambient zone 242 is unlit. In the functional condition, there may be a sharp cutoff or transition between the functional zone 244 and the remaining ambient zone 242. More specifically, the functional zone 244 that is lit may transition within a particular distance to unlit ambient zone 242. In some embodiments, the particular distance may be 5 mm, 6 mm, 7 mm, 8 mm, 9 mm, 10 mm, 11 mm, 12 mm, 13 mm, 14 mm, 15 mm, or any range of values therebetween.

FIG. 2B is an embodiment of the lighting system 100 shown in FIG. 2A in an ambient condition. In the present embodiment, the ambient zone 242 comprises the space taken up by both of the functional zones 244. The ambient zone 242 may take up the entirety of the outer lens 240 or only a portion of the outer lens 240. The ambient zone 242 may comprise the entirety of the functional zones 244, a portion of the functional zones 244, or none of the functional zones 244. The lighting system 100 may comprise a single ambient zone 242 or multiple ambient zones 242. When the lighting system 100 is in an ambient condition, the ambient zone 242 is lit. When the ambient zone 242 is lit, the lighting system 100 provides an ambient light 122.

FIG. 3A is a side view of an embodiment of the lighting system 100 in a functional condition. A functional LED 144 is mounted on or connected to the functional PCB 140 and emits an initial functional light 146. The initial functional light 146 passes through the functional optic 200. The functional optic 200 directs the light to form the desired directional light 142. The directional light 142 passes though the micro optic 220 with minimal distortion. The functional light then passes through the outer lens 240. When the functional light 142 passes through the outer lens 240 it appears on the outer lens 240 as a distinct section, the functional zone 244, seen in FIG. 2A. As shown in FIG. 3A, the functional light 142 travels substantially toward a particular direction after passing through the outer lens 240.

In some embodiments, the functional LED 144 may be implemented by various types of light emitting diode (LED). For example, the functional LED 144 may be through hole LED, surface mount LED, or other types of LED. It should be noted that, although the functional LED 144 is illustrated as a light source of the lighting system 100, the functional LED 144 may be replaced by other types of light sources, such as fluorescent lights, and incandescent lights.

In the present embodiment the functional LED 144 is configured substantially parallel to the functional optic 200 and the outer lens 240 such that the light emitted from the functional LED 144 follows a substantially straight path through the functional optic 200, through the micro optic 220, and then through the outer lens 240. The functional optic may be designed to focus the directional light to a desired intensity and distribution. This may be achieved through textures on the surfaces of the lens, structures within, coatings, overall shape of the function optic 200, or through any specular/directional optics principles known in the art.

FIG. 3B is a side view of an embodiment of the lighting system 100 in an ambient condition. At least one ambient LED 124 is connected to the ambient PCB 120 and emits an initial ambient light 126. The initial ambient light 126 is directed into the micro optic 220. The micro optic 220 diffuses and directs the light to form the desired ambient light 122. The ambient light 122 then passes through the outer lens 240. As shown in FIG. 3B, the initial ambient light 126 is directed in the micro optic 220 from a side of the micro optic 220.

In some embodiments, as noted above, there may be a gap between the functional optic 200 and the functional PCB 140. The gap between the functional optic 200 and the functional PCB 140 may be about 1 micrometer (μm), 5 μm, 10 μm, 15 μm, 20 μm, 25 μm, 30 μm, 35 μm, 40 μm, 45 μm, 50 μm, 75 μm, 100 μm, 150 μm, 200 μm, or any range of values therebetween. Advantageously, the optical design associated with the gaps may enable the functional optic 200 to collimate or direct light from the functional LED 144.

In the present embodiment, the ambient LED 124 is configured substantially perpendicular to the micro optic 220 and to the outer lens 240 such that the path of the light emitted from the ambient LED 124 is substantially altered. The substantially altered light path 128 comprises at least one redirection 130. The redirection 130 can occur within the micro optic 220 or on a surface of the micro optic 220. The micro optic 220 may be configured to produce a desired diffusion or direction for ambient light, as well as the functional/directional light. This may be achieved through textures on the surfaces of the lens, structures within, coatings, and or overall shape of the micro optic 220.

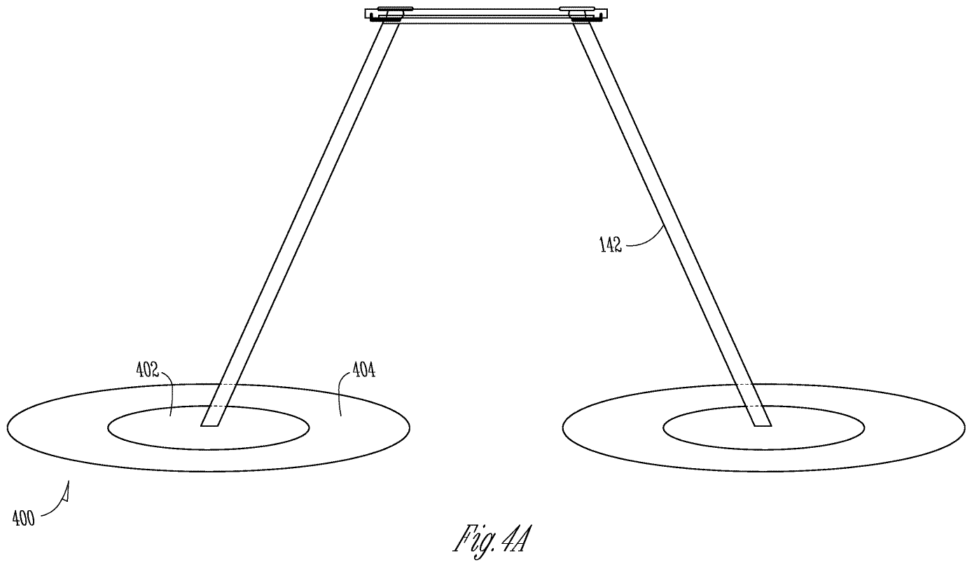

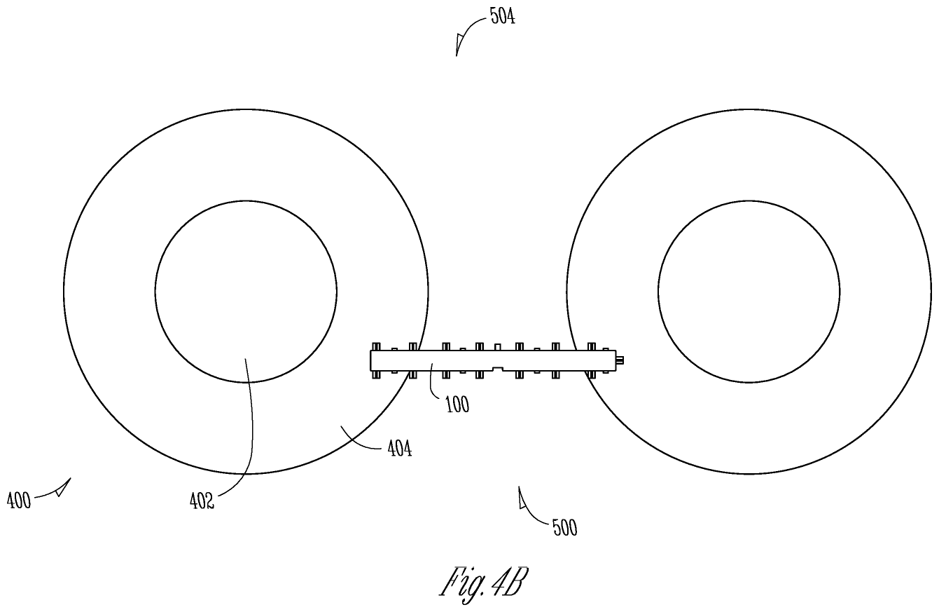

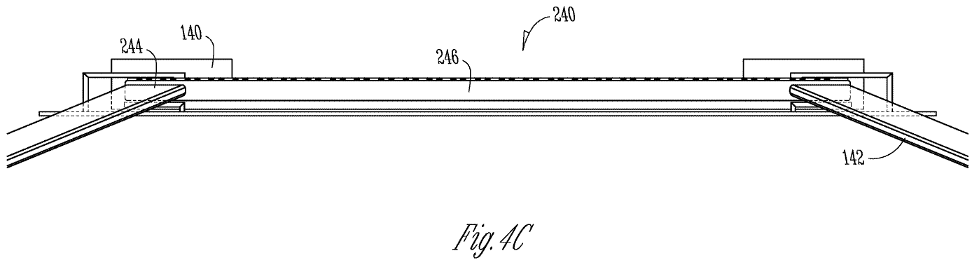

FIG. 4A is an embodiment of the lighting system 100 in a functional condition. The figure illustrates the path of the functional light 142 as well as a functional intensity representation 400, representing the intensity of the light when it reaches a surface. The functional intensity representation 400 may comprise a first zone 402 and a second zone 404. The first zone 402 may represent a more intense light than the second zone 404. The first zone 402 may be located within the second zone 404. There may be a single zone, there may be two zones as shown in the present embodiment, or there may be more zones than shown. The intensity in the first zone 402 may be 50 lux and the intensity in the second zone may be 10 lux. The intensity of the zones may be an average taken across the area of the zone.

In some embodiments, the first zone 402 may form a circular area having a diameter of 100 mm, 110 mm, 120 mm, 130 mm, 140 mm, 150 mm, 160 mm, 170 mm, 180 mm, 190 mm, 200 mm, or any range of values therebetween. The second zone 404 may have a diameter of 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, or any range of values therebetween. In some embodiments, the intensity of the first zone may be 40 lux, 42 lux, 44 lux, 46 lux, 48 lux, 50 lux, 52 lux, 54 lux, 56 lux, 58 lux, 60 lux, or any range of values therebetween. In some embodiments, the intensity of the second zone may be 5 lux, 6 lux, 7 lux, 8 lux, 9 lux, 10 lux, 11 lux, 12 lux, 13 lux, 14 lux, 15 lux, or any range of values therebetween. In some embodiments, light intensity may decrease gradually from the center of the first zone 402 toward the boundary of the second zone 404. For example, light intensity may decrease gradually from 50 lux around the center of the first zone 402 to 10 lux around the boundary of the second zone 404.

FIG. 4B is an alternative view of the lighting system 100 shown in FIG. 4A. The lighting system 100 is in a functional condition. The present embodiment is located in a vehicle with a forward car section 500 and a rearward car section 504. The lighting system 100 may be located in an overhead console. The overhead console may be located behind a windshield within the cab of the vehicle.

FIG. 4C is an alternative view of the lighting system 100 shown in FIG. 4A. In FIG. 4C, the front surface 246 of the outer lens 240 is in a functional condition. The functional zone 244 is lit as the functional light 142 passes through the outer lens 240. The front surface 246 of the outer lens 240 may be smooth or textured.

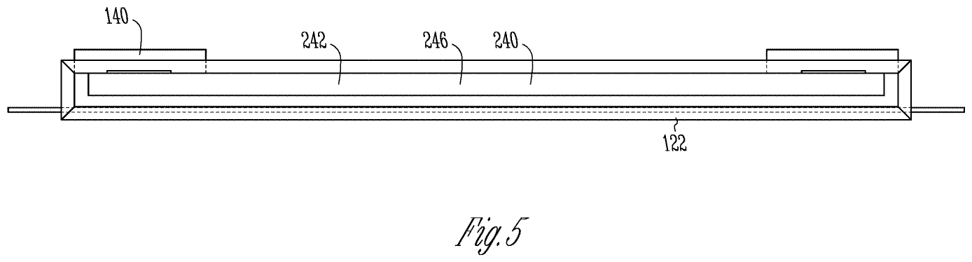

FIG. 5 is an embodiment of the lighting system 100 in an ambient condition from the same perspective as FIG. 4B. The ambient light 122 is shown passing through the outer lens 240 in the ambient zone 242.

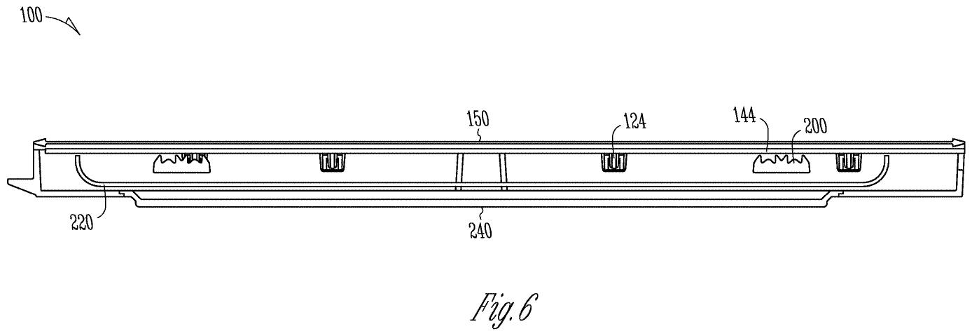

FIG. 6 is an illustration of an alternative embodiment of the lighting system 100. In the present embodiment, the lighting system 100 comprises a single combined PCB 150. The combined PCB 150 comprises both functional LEDs 144 and ambient LEDs 124. The functional LEDs 144 and the ambient LEDs 124 are located along the combined PCB 150. The functional LEDs 144 and the ambient LEDs 124 may be spaced equally or in an alternative pattern.

The lighting system 100 further comprises a function optic 200 and a textured light guide 220. In some embodiments, instead of emitting light from a side of the texture light guide 220 as illustrated in FIG. 3B, the texture light guide 220 may include a curvature portion that collects, collimates, and redirects light emitted from the ambient LEDs 124 to the outer lens 240.

When in a function condition the functional LEDs 144 are lit. The light from the functional LEDs 144 passes through the functional optic 200 where the light is redirected into a directed beam 142. The functional light 142 passes through the textured light guide 220 with minimal diffusion and then passes through the outer lens 240. The functional light passes through a functional zone 244 of the outer lens 240. The present embodiment has two sets of functional LEDs 144, two sets of functional optic 200, and two sets of functional zones 244 (not shown in FIG. 6).

When in an ambient condition the functional LEDs 144 are lit. The ambient LEDs 124 may also be lit. The functional LEDs 144 and the ambient LEDs 124 may be lit to the same power level or different power levels, specifically the functional LEDs may be lit to a lower power level than the ambient LEDs. In the present embodiment, only the ambient LEDs 124 are lit when in the ambient condition. The ambient LEDs 124 emit light that passes through the textured light guide 220. The light is diffused and redirected. The ambient light 122 then passes through the outer lens 240. The ambient zone 242 is lit such that an ambient light is emitted from the outer lens 240.

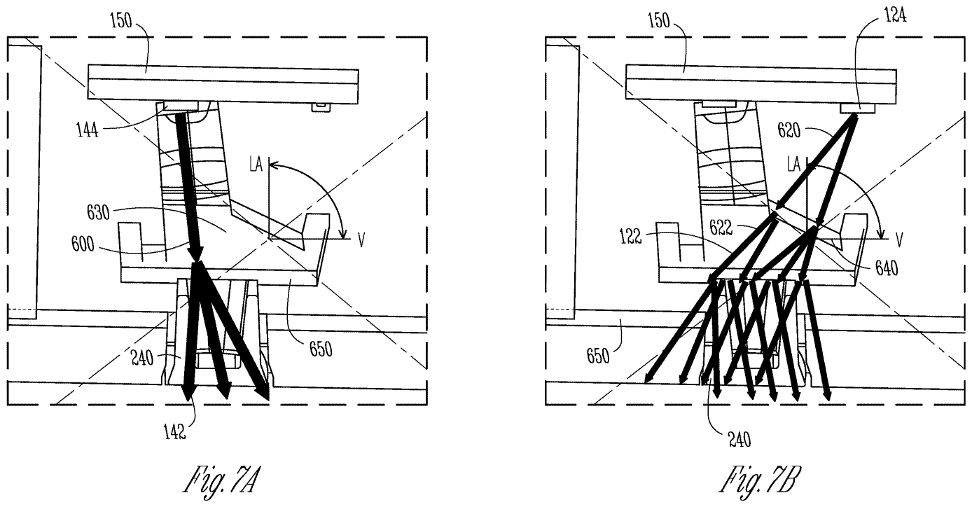

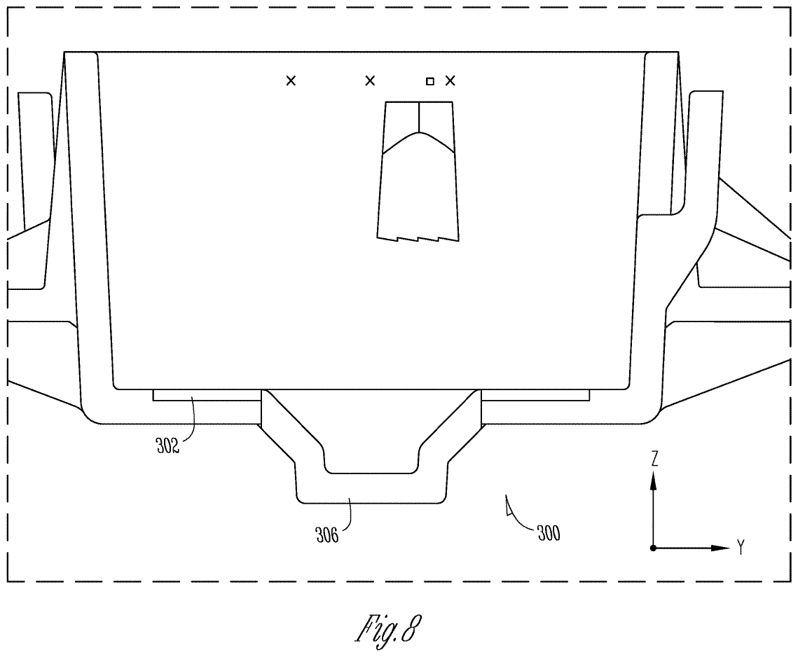

FIGS. 7A and 7B are illustrations of an alternative embodiment of the lighting system 100. In the present embodiment, the lighting system 100 comprises a single combined PCB 150. The combined PCB 150 comprises both functional LEDs 144 and ambient LEDs 124. The functional LEDs 144 and ambient LEDs 124 are located side by side along the combined PCB 150. They may be spaced equally or in an alternative pattern.

FIGS. 7A and 7B further illustrate the lighting system 100 can include a single optic 630 that includes the first diffuse material 640 and the second diffuse material 650. In some embodiments, the single optic 630 may be made of materials such as poly methyl methacrylate (PMMA) or acrylic. The first diffuse material 640 and the second diffuse material 650 may be made of the same material as the rest of the single optic 630, except the first diffuse material 640 and the second diffuse material 650 may have different textures or grains from the rest of the single optic 630. As shown in FIGS. 7A and 7B, the combined PCB 150 is positioned on top of the single optic 630.

FIG. 7A shows the lighting system 100 in a functional condition. The functional LED 144 emits a light shown by the first functional arrow 600. The light then passes through a second diffuse material 650. The second diffuse material 650 may be similar or the same as the textured light guide or micro optic 220. The light is minimally diffused and directed. The functional light 142 then passes through the outer lens 240. The light passes through the functional zone 244 of the outer lens 240.

FIG. 7B is an illustration of an alternative embodiment of the lighting system 100 shown in FIG. 7A. In the ambient condition the ambient LED 124 emits a light, shown by the first ambient arrow set 620. The light then passes through a first diffuse material 640 where it is redirected and diffused. The light is able to better diffuse with the space between the ambient LED 124 and the first diffuse material 640. After exiting the first diffuse material 640 the light represented by the second ambient arrow set 622 passes through the second diffuse material 650. As the ambient light 122 passes through the second diffuse material it is further diffused and redirected to form a uniform ambient light 122. The ambient light 122 then passes through the outer lens 240. The light passes through the ambient zone 242 of the outer lens 240.

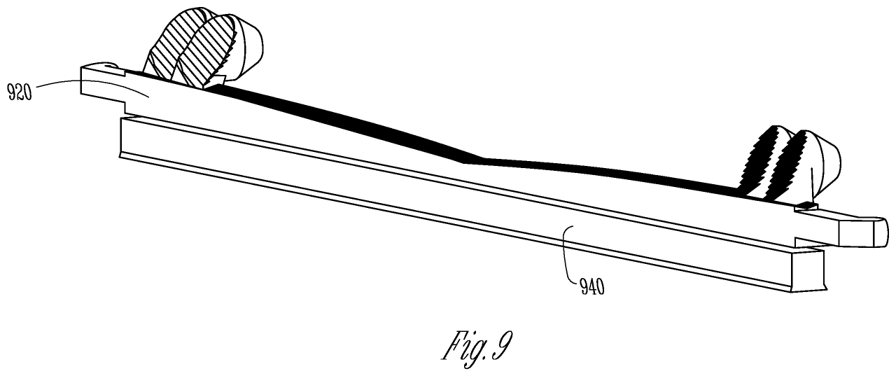

FIG. 8 is an illustration of the touch sensor 300. The functional light condition and the ambient light condition may be controlled through the touch sensor 300. The electrodes 302 of the touch sensor 300 are located on both sides of the outer lens 240. The electrode sensors may be located such that the touch sensing zone is the same as or similar to the functional zones 244. The touch sensing may be by mutual capacitance. The electrodes 302 may be conductive copper electrodes (capacitor plates) which create an electric field in which changes in capacitance (finger touch) are measured. The touch sensor 300 may operate in alternative methods such as infrared sensing, time of flight sensing, or a mechanical driven touch which deflects, clicks, slides, moves, engages, or presses. All of these alternative methods may be used on the outer lens 240.

The electrodes 302 may be coplanar. The electrodes 302 may be copper or other metallic electrodes. The touch sensor 300 may detect a touch on a touch surface 306 between the electrodes 302. The touch surface 306 may be a portion of a surface of the outer lens 240. The distance between the electrodes may be 8 mm or it may be greater than 8 mm. The distance between the electrodes 302 may be the same as, or larger than, the height of the outer lens 240. The touch sensor 300 may be able to sense a touch anywhere between the electrodes 302, which may be co-planar. Further, the touch sensor 300 may be able to additionally sense a touch on an electrode 302. Advantageously, sensing a touch between electrodes allows the system to maintain a clear light path. Traditional touch systems may require an electrode at the touch surface 306, which would block a light path.

As noted above, instead of utilizing mutual capacitance detection through electrodes, other touch sensing techniques may be utilized for turning on or off the ambient LED 124 and/or the functional LED 144. In some embodiments, a touch sensor may sense a user touch on the touch surface and translate the user touch to an electrical signal to be transmitted to a PCB (e.g., the ambient PCB 120) of the lighting system 100. For example, the touch sensor may be a strain sensor. When a user touches the touch surface, a force is detected by the strain sensor. The strain sensor may translate the force to an electrical signal for transmission to a PCB. Based on the electrical signal, the lighting system 100 can detect a user touch on the touch surface. In this example, the electrodes 302 may be removed. Additionally and/or optionally, the strain sensor may be deployed at or on top of the touch surface to detect a user touch on the touch surface.

In some embodiments, other sensing techniques that do not utilize a user touch may be employed by the lighting system 100. For example, the lighting system 100 may utilize an infrared (IR) sensor or a photo detector to sense a gesture of a user for controlling the ambient LED 124 and/or the functional LED 144. As such, responsive to a user interaction with a sensor of the lighting system 100, the sensor may cause the ambient LED 124 and/or the functional LED 144 to be turned on or off. For example, responsive to a user touch on a touch surface of the outer lens 240, the touch sensor 300 may cause the functional LED 144 to be turned on or off.

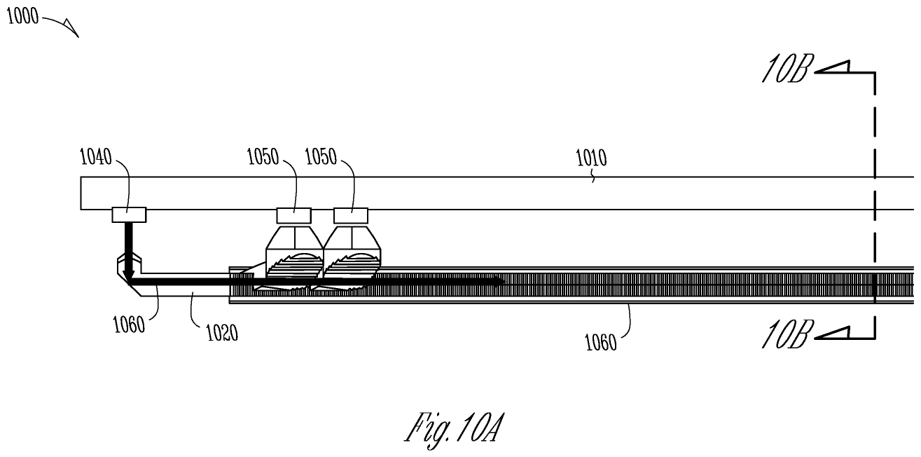

FIG. 9 illustrates a representation of a single optic 920 and an outer lens 940. The single optic 920 and the outer lens 940 may be implemented as or substituted to be a portion of the lighting system 100. For example, the single optic 920 may correspond to or substitute for the micro optic 220 and the functional optic 200, and the outer lens 940 may correspond to or substitute for the outer lens 240. In some implementations, the single optic 920 may be made of materials such as poly methyl methacrylate (PMMA) or acrylic. Although not illustrated in FIG. 9, the single optic 920 may receive light from one or more light sources, such as a light from the functional LED 144 and a light from the ambient LED 124. The one or more light sources may be mounted on a PCB that is positioned above the single optic 920 and the outer lens 940. Alternatively, the PCB may be positioned on a side of the single optic 920 and the outer lens 940.

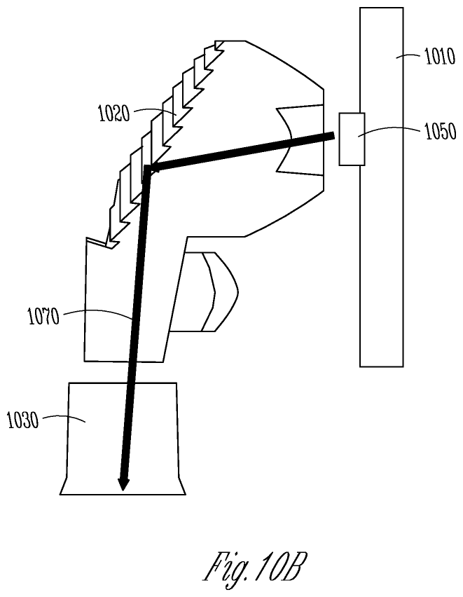

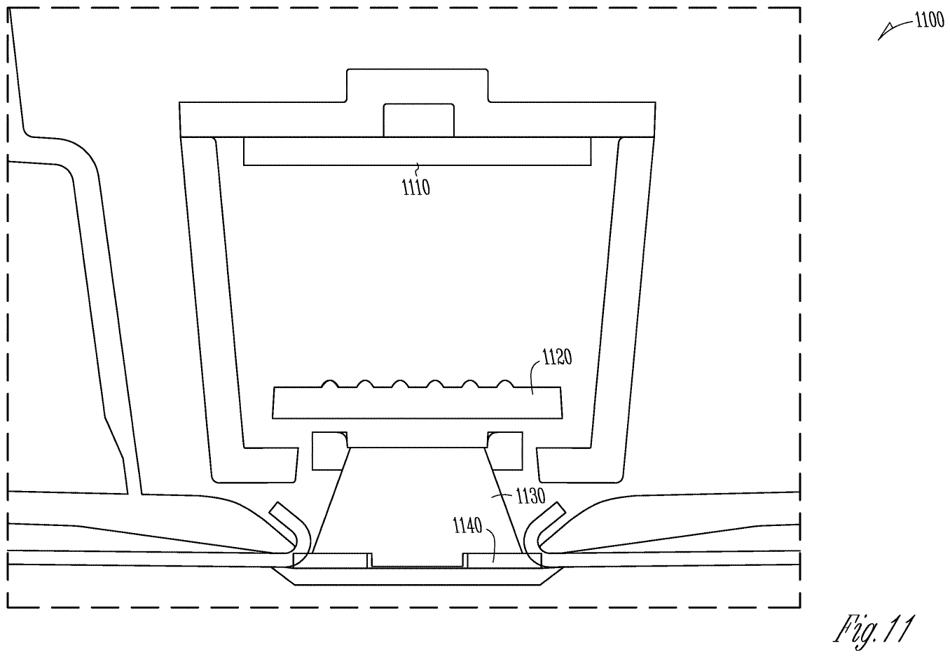

FIG. 10A illustrates a top view of a lighting system 1000 in accordance with some aspects of the present application. In certain embodiments, the lighting system 1000 includes a PCB 1010, a single optic 1020, an outer lens 1030, an ambient LED 1040, and two functional LEDs 1050. As illustrated in FIG. 10A, the ambient LED 1040 and the functional LEDs 1050 are mounted on the PCB 1010. The single optic 1020 may receive light from the ambient LED 1040. The single optic 1020 may further receive light from each of the functional LEDs 1050. As shown in FIG. 10A, light 1060 from the ambient LED 1040 may travel through an ambient light path through the single optic 1020. The light 1060 from the ambient LED 1040 may further be received and diffused by the outer lens 1030.

In some implementations, the single optic 1020 may receive the light from the ambient LED 1040 to generate a first light. The single optic 1020 may receive a light from the functional LED 1050 to generate a second light. The outer lens 1030 may include an ambient zone and a functional zone. The ambient zone may receive the first light and diffuse the first light into an ambient light that travels in a plurality of directions. The functional zone may receive the second light and diffuse the second light into a directional light that travels substantially in a single direction.

FIG. 10B illustrates a cross-sectional view of the lighting system 1000 in accordance with some aspects of the present application. As shown in FIG. 10B, the single optic 1020 may receive light 1070 from the functional LED 1050. The light 1070 from the functional LED 1050 may further be received and diffused by the outer lens 1030.

FIG. 11 illustrates a cross-sectional view of a lighting system 1100 in accordance with some aspects of the present application. The lighting system 1100 may provide the same or similar functionalities compared with the lighting system 100 and/or the lighting system 1000. As illustrated in FIG. 11, the lighting system 1100 includes a PCB 1110, an ambient optic 1120, an outer lens 1130, and an adhesive layer 1140. The adhesive layer 1140 may include certain coating, filming, or painting materials that are applied to a surface of the outer lens 1130 such that the lighting system 1100 may exhibit appearances associated with the materials applied to the outer lens 1130.

For example, a metallic physical vapor deposition (PVD) coating may be applied to a portion of the outer lens 1130 such that when the lighting system 1100 does not emit or generate light, the lighting system 1100 may present metallic or dark color (e.g., black) appearance to a user rather than the appearance of the material that is included in the outer lens 1130. Other materials that may be applied to a surface of the outer lens 1130 include materials such as in mold label (IML) films, Shytech paint, or the like. Advantageously, coating, filming or painting on the outer lens 1130 may increase aesthetic appeal of the lighting system 1100.

It should be understood that the components described in this disclosure may be used outside of vehicles. The components described may be applicable in the aerospace, robotic, manufacturing equipment, industrial equipment, or other areas.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A lighting system comprising:
a first light source,
a second light source;
a first optic configured to receive light from the first light source for scattering into a first light;
a second optic configured to receive light from the second light source for directing into a second light; and
an outer lens comprising an ambient zone and a functional zone, wherein the ambient zone is configured to receive the first light, wherein the functional zone is configured to receive the second light, and wherein:
the ambient zone diffuses the first light into an ambient light that travels in a plurality of directions when the ambient zone receives the first light; and
the functional zone diffuses the second light into a directional light that travels substantially in a direction when the functional zone receives the second light.

2. The lighting system of claim 1, further comprising:
a first printed circuit board (PCB); and
a second printed circuit board (PCB),
wherein the first light source is mounted on the first PCB, and wherein the second light source is mounted on the second PCB.

3. The lighting system of claim 2, wherein the second optic is positioned below the second PCB and above the first optic.

4. The lighting system of claim 3, wherein the first optic is positioned below the second optic and above the outer lens, and wherein the second light passes through the first optic before being received by the functional zone.

5. The lighting system of claim 3, wherein the second optic is adjacent to a bottom surface of the second PCB and a top surface of the first optic, and wherein the bottom surface of the second PCB and the top surface of the first optic are substantially parallel.

6. The lighting system of claim 5, wherein the bottom surface of the second PCB and the top surface of the first optic are substantially perpendicular to a surface of the first PCB that is adjacent to the first optic.

7. The lighting system of claim 2, further comprising:
a sensor electrically connected to the first PCB,
wherein the sensor is configured to cause the first light source or the second light source to be turned on or off responsive to a user interaction.

8. The lighting system of claim 7, wherein the sensor is a touch sensor, and wherein the touch sensor causes the second light source to be turned on or off responsive to a user touch on a touch surface of the outer lens.

9. The lighting system of claim 8, wherein the touch sensor comprises a first electrode and a second electrode, and wherein the touch surface of the outer lens is positioned between the first electrode and the second electrode.

10. A lighting system comprising:
a first light source;
a second light source;
a first optic configured to receive light from the first light source for generating a first light;
a second optic configured to receive light from the second light source for generating a second light; and
an outer lens comprising an ambient zone and a functional zone, wherein the ambient zone is configured to diffuse the first light into an ambient light, and wherein the functional zone is configured to diffuse the second light into a directional light.

11. The lighting system of claim 10, wherein the functional zone is positioned around a first end and/or a second end of the outer lens.

12. The lighting system of claim 10, further comprising:
a printed circuit board (PCB),
wherein the first light source and the second light source are mounted on the PCB.

13. The lighting system of claim 12, wherein the first optic is positioned below the PCB and above the outer lens.

14. The lighting system of claim 13, wherein the second optic is positioned between the PCB and the first optic.

15. A lighting system comprising:
a first light source;
a second light source;
an optic configured to:
receive light from the first light source for generating a first light; and
receive light from the second light source for generating a second light; and
an outer lens comprising an ambient zone and a functional zone, wherein the ambient zone is configured to diffuse the first light into an ambient light, and wherein the functional zone is configured to diffuse the second light into a directional light.

16. The lighting system of claim 15, wherein the optic comprises a first portion and a second portion, wherein the light from the first light source passes through the first portion and the second portion for generating the first light, and wherein the light from the second light source passes through the second portion for generating the second light.

17. The lighting system of claim 15, further comprising:
a printed circuit board (PCB),
wherein the first light source and the second light source are mounted on the PCB.

18. The lighting system of claim 17, wherein the PCB is positioned above the outer lens and the optic.

19. The lighting system of claim 15, wherein a length of the outer lens is about 300 mm, and wherein a length of the functional zone is between 20 mm to 30 mm.

20. The lighting system of claim 15, wherein the ambient zone is larger in size than the functional zone, and wherein the ambient zone overlaps with the functional zone.

21. A lighting system comprising:
at least one PCB;
at least one ambient LED;
at least one functional LED;
a first optic configured to receive a light from the at least one ambient LED and diffuse said light into a first light;
a second optic configured to receive light from the at least one functional LED and direct it into a second light; and
an outer lens comprising a functional zone and an ambient zone,
wherein the second light is further directed through the first optic, wherein the first light is more diffuse than the second light, wherein the second light is configured to path through the functional zone and the first light is configured to pass through the ambient zone, and wherein the functional zone and the ambient zone are at least partially the same.

22. A lighting system comprising:
an ambient PCB;
a functional PCB;
at least one ambient LED mounted to the ambient PCB;
at least one functional LED mounted to the functional PCB;
a first optic configured to receive a light from the at least one ambient LED and diffuse said light into a first light;
a second optic configured to receive light from the at least one functional LED and direct it into a second light;
an outer lens comprising a functional zone and ambient zone; and
a touch sensor configured to sense a user touch of the outer lens,
wherein the functional PCB is substantially perpendicular to the ambient PCB, wherein the second light is configured to path through the functional zone and the first light is configured to pass through the ambient zone, and wherein the functional zone and the ambient zone are at least partially the same.

23. A lighting system for a vehicle, the lighting system comprising:
at least one ambient LED;
at least one functional LED;
a first optic configured to receive a light emitted by the at least one ambient LED and diffuse said received light into a first light;
a second optic configured to receive a light emitted by the at least one functional LED and direct the received light into a second light; and
an outer lens comprising an ambient zone positioned to receive the first light and a functional zone positioned to receive the second light, at least a portion of the functional zone overlapping the ambient zone.
